(19) United States
(12) Patent Application Publication
(10) Pub. No.: US 2017/0245505 A1
(43) Pub. Date: Aug. 31, 2017

(54) HERBAL ESSENTIAL OIL FOR BIOMATERIAL PRESERVATION

(71) Applicant: RUTGERS, THE STATE UNIVERSITY OF NEW JERSEY, New Brunswick, NJ (US)

(72) Inventors: Thomas Gianfagna, New Brunswick, NJ (US); Jeanne Peters, New Brunswick, NJ (US); Kit Yam, New Brunswick, NJ (US)

(73) Assignee: RUTGERS, THE STATE UNIVERSITY OF NEW JERSEY, New Brunswick, NJ (US)

(21) Appl. No.: 15/512,914

(22) PCT Filed: Sep. 22, 2015
(86) PCT No.: PCT/US15/51433

§ 371 Date: Mar. 21, 2017

Related U.S. Application Data
(60) Provisional application No. 62/053,580, filed on Sep. 22, 2014.

(51) Int. Cl. A01N 65/22; B65D 81/28; A01N 31/08; A23B 7/154; A01N 3/02

(52) U.S. Cl. CPC A01N 65/22; A23B 7/154; A01N 3/02; A01N 31/08; B65D 81/28; A23V 2002/00

(57) ABSTRACT

Compositions and methods for inhibiting the decomposition of agricultural products are provided. A composition comprises a breathable sachet of cyclodextrin-encapsulated plant essential oils, such as thyme oil. Another composition comprises a mixture of a plant essential oil, protein, wax and glycerine used as a coating on at least one inner surface of a defined space such as a storage, shipping or delivery container or a flower sleeve. A method comprises addition of the composition to a defined space containing, or designed to contain, an agricultural product such as a fruit, vegetable or cut flower.

### STATEMENT OF GOVERNMENT INTEREST

This invention was made with government support under Grant Number NJAES project 12125, awarded by the United States Department of Agriculture-National Institute of Food and Agriculture. The government has certain rights in the invention.

### FIELD

The disclosure relates generally to the preservation of packaged biomaterials including foodstuffs such as fruits and vegetables as well as cut flowers.

### BACKGROUND

Perishable agricultural products, such as fruits, vegetables, and cut flowers, are lost to decomposition caused by microbes. Such products are often stored for time periods sufficient to allow propagation of various microorganisms. In short order, a high percentage of the products becomes infected. In addition to the obvious substantial financial loss due to such decay, some of these microorganisms produce toxic and carcinogenic metabolites harmful to humans.

Control of pathogen infection of perishable agricultural products is currently achieved mainly by exogenous application of synthetic fungicides and/or bactericides. These synthetic chemicals, however, often leave toxic residue. Selection for resistant strains of microorganisms is also a concern that has been realized. As a result, several such fungicides and bactericides are being phased out by manufacturers and regulatory agencies monitoring the safety and quality of agricultural products. The toxicity, long-term loss of efficacy, and government-imposed phase-outs of synthetic approaches to the control of decay have led to the development of alternative approaches.

Irradiation of agricultural products, such as ultraviolet irradiation, has been proposed as an alternative to the application of synthetic chemicals. UV irradiation, however, can be phytotoxic and must satisfy regulators that its application can be effective in reducing microbial-induced decay without harming the agricultural product. Moreover, the cost of irradiating many agricultural products renders the approach impractical.

Biological control agents have also been considered. Loss of citrus fruit crops to fungal rot has led to the proposed use of yeast and/or bacteria antagonistic to the rot-inducing fungal species. Biocontrol with antagonistic organisms such as yeast has not received commercial acceptance, possibly because of inadequate control of the antagonistic organisms, which can be pathogens in their own right. Furthermore, some regulatory agencies have not yet approved their use.

Plant essential oils are naturally occurring compounds that have been shown to possess microbiostatic and microbiocidal properties. As natural compounds, their use to preserve agricultural products might be expected to pose less risk than synthetic chemical approaches. Unfortunately, application of essential oils to many agricultural products results in direct damage to the products in the form of peel damage in fruits and other forms of damage in various agricultural products, including packaged meats and grains stored in elevators. In addition, many bioactive essential oils are sparingly soluble in water, complicating their delivery.

Various compounds and structures have been proposed as delivery vehicles for bioactive compounds. One example is the cyclodextrins (i.e., cycloamyloses), which are cyclic oligosaccharides built up from 6-, 7- or 8-α(1-4)-linked anhydroglucose units. The α-, β- or γ-cyclodextrins are produced by enzymatic hydrolysis of starch. These compounds differ in the diameter of their hydrophobic cavity and are generally suitable for the inclusion of numerous hydrophobic substances. Typical of worldwide reaction to these compounds, cyclodextrins have been approved by the US FDA and European regulatory agencies have permitted their ingestion by humans for several years. In use, the cyclodextrin delivery vehicle is typically induced to release its cargo by a change in pH, the application of heat, or by enzymatic degradation of the cyclodextrin. These approaches work well in administering various nutritional or therapeutic compounds to a body, but do not work so well when the goal is the gradual, continuous release of the cargo.

Accordingly, a need persists for materials and methods to inhibit or prevent microbe-mediated degradation of agricultural products, including fruits, vegetables, grain, meat and cut flowers that is safe for consuming populations, effective in reducing or eliminating loss due to decomposition, and economically feasible.

### SUMMARY

The disclosure provides a cost-effective solution to the problem of microbe-mediated degradation of organic matter such as agricultural products by harnessing the anti-microbial properties of volatile essential oils of herbs, such as Thyme oil, and controlling the release of such anti-microbial oils in a manner that inhibits, prevents or delays microbe-mediated degradation or decomposition of biomaterials such as agricultural products in the form of produce (whole and cut fruits and vegetables), cut flowers, and the like. The methods of the disclosure are suitable for addressing the degradation of biomaterials caused by a wide variety of microbes, including prokaryotic and eukaryotic microbes, such as species of the Botrytis genus (e.g., Botrytis cinerea).

In one aspect, the disclosure provides a composition to reduce microbe-mediated decomposition of organic matter in a defined space comprising a breathable sachet of encapsulated herbal essential oil. In another aspect, the disclosure provides a composition to reduce microbe-mediated decomposition of organic matter in a defined space (e.g., an enclosed, or closed, space) comprising a mixture of encapsulated herbal essential oil, soy protein isolate, paraffin wax and glycerine. In some embodiments of either of these aspects of the disclosure, the herbal essential oil is obtained from thyme, such as thymol.

In some embodiments of either of these aspects of the disclosure, the herbal essential oil is encapsulated in cyclodextrin. The cyclodextrin may be any cyclodextrin known in the art, such as a cyclodextrin selected from the group consisting of α-cyclodextrin, β-cyclodextrin and γ-cyclodextrin. The disclosure extends to derivatives of cyclodextrins, such as embodiments wherein a β-cyclodextrin derivative is used, such as methyl-β-cyclodextrin.

The breathable sachet in this aspect of the disclosure may be any breathable barrier material, such as a breathable fiber composition or membrane. Exemplary breathable sachets are contemplated, wherein the sachet comprises a Tyvek® membrane, a Typar® membrane or a Kleenguard® A40 membrane.

The disclosure provides compositions and methods to reduce or eliminate microbe-mediated decomposition of organic matter caused by any of a wide variety of microbes, which includes bacteria, fungi such as yeasts and molds, and protozoans that are typically parasitic. Some embodiments of the composition according to the disclosure reduce or eliminate microbe-mediated decomposition attributable to a species of Botrytis, Listeria, Clostridium, Salmonella, Shigella, Escherichia, Cryptosporidium, Giardia, Cyclospora, Pseudomonas, Xanthomonas, Zoogloea, Frauteuria, Lactobacillus, Pediococcus, or Leuconostoc. In some particular embodiments, the composition is useful in reducing or eliminating decomposition attributable to a species of the Botrytis genus, such as decomposition attributable to Botrytis cinerea.

The disclosure also provides a storage container for an agricultural product comprising the sachet as disclosed herein and/or a coating of the composition disclosed herein. The storage container can be impervious to aqueous vapors, such as plastic film, or exhibit a degree of permeability to aqueous vapors, such as the various housewraps (e.g., Tyvek®, Typar®, Kleenguard® A40, Homeguard®).

The disclosure also provides a storage container for an agricultural product comprising a coating of the encapsulated herbal essential oil described herein. In some embodiments, the coating of encapsulated herbal essential oil further comprises a mixture of other components selected from the group consisting of protein, wax and glycerine. In some embodiments, the storage container comprises a coating useful for reducing or eliminating decomposition of the agricultural product, wherein the coating comprises a mixture of the encapsulated herbal essential oil described herein, soy protein isolate, paraffin wax and glycerine.

As would be apparent to one of ordinary skill in the art, the storage container disclosed herein may also comprise organic matter (biomaterial), such as one or more agricultural products. In embodiments comprising a plurality of agricultural products, those products can be the same (e.g., cantaloupe, cut roses) or different (e.g., a bouquet of flowers). In some embodiments, the storage container comprises an agricultural product wherein the agricultural product is a fruit, a vegetable or a cut flower.

Another aspect of the disclosure is drawn to a method of inhibiting the decomposition of an agricultural product comprising adding a sachet as disclosed herein to a closed space comprising the agricultural product. In some embodiments, the closed space is a storage container, a shipping container or a delivery container. In some embodiments, the method further comprises adjusting the humidity in the closed space.

Another aspect of the disclosure is drawn to a method of inhibiting the decomposition of an agricultural product comprising applying a coating of a composition useful for reducing or eliminating decomposition of the product to at least one surface of a closed space comprising the agricultural product. In some embodiments, the closed space is a storage container, a shipping container or a delivery container. In some embodiments, the composition comprises a mixture of the encapsulated herbal essential oil described herein, soy protein isolate, paraffin wax and glycerine.

Other features and advantages of the disclosure will become apparent from the following detailed description. It should be understood, however, that the detailed description and the specific examples, while indicating specific embodiments of the disclosure, are given by way of illustration only, because various changes and modifications within the spirit and scope of the disclosure will become apparent to those skilled in the art from this detailed description.

### DETAILED DESCRIPTION

The disclosure provides materials and methods for reducing, eliminating, inhibiting, preventing or delaying microbe-mediated degradation or decomposition of organic matter (i.e., biomaterial) in the form of, e.g., agricultural products such as whole or cut fruits, vegetables, flowers and other ornamentals, and landscaping products. The materials include controlled-release packaging for at least one volatile anti-microbial essential oil, such as Thyme essential oil (e.g., Thymol). Without wishing to be bound by theory, the disclosure packages the volatile active agent in a material exhibiting some permeability to aqueous vapors, but not to aqueous liquids. The organic matter, e.g., agricultural product, being preserved, or having its useful life extended, transpires in a closed or semi-closed environment with the packaged active agent. The transpired water vapor passes through the packaging, displacing the volatile essential oil inside the packaging, leading to its progressive release in a manner that promotes extended inhibition, prevention or delay of microbe-mediated degradation of the organic matter.

A “breathable” sachet as used herein means a sachet that is permeable to water vapor, but not to liquid water. An example of a breathable sachet material is a flash-spun high-density polyester fiber material such as Tyvek®. In general, house wrap materials, e.g., Typar®, Kleenguard® A40, Homeguard®, and the like, present the desired properties of permeability to water vapor, but not liquid water.

A “composition” according to the disclosure is any anti-microbial compound or mixture of compounds capable of being transported by a gas (e.g., an aqueous vapor) prior to exerting an anti-microbial effect on a microbe capable of degrading or decomposing, in part, organic matter such as agricultural products including whole and cut fruits, vegetables, flowers and other ornamentals, as well as landscaping materials.

A “microbe” refers to a microorganism, which may be eukaryotic or prokaryotic, consistent with the meaning of the term in the art. Microbes capable of mediating decomposition of organic matter (plant or animal) according to the disclosure include fungi such as yeast or a mold (e.g., gray mold), a bacterium (e.g., a gram-positive bacterium, a gram-negative bacterium, an archaebacterium), or a protozoan, such as a parasite (e.g., Cryptosporidium, Giardia duodenalis (or G. lamblia), Cyclospora cayetanensis). In general, these microbes mediating decomposition include, but are not limited to, Pseudomonadaceae, including the Pseudomonas, Xanthomonas, Zoogloea and Frauteuria genera, lactic acid bacteria, including the Lactobacillus delbrueckii group, the Lactobacillus/Pediococcus group and the Leuconostoc group, fungi, such as yeasts and molds (e.g., gray mold), and pathogenic microbes, including pathogenic bacteria and protozoan parasites. Exemplary bacterial species according to the disclosure include species of the Botrytis genus, such as Botrytis cinerea, as well as Listeria species (e.g., L. monocytogenes), Clostridium species (e.g., C. botulinum), Salmonella species (e.g., S. perfringens), Shigella species (e.g., S. flexneri, S. dysenteriae, S. sonnei) and Escherichia species (e.g., E. coli O157:H7).

“Microbe-mediated decomposition” or “microbe-mediated degradation” mean a loss in the apparent health and/or vigor of organic matter such as agricultural products. As those of skill in the art would recognize, a change in color, texture, flexibility, resilience, odor, taste, and other properties known in the art are associated with decomposition or degradation mediated by microbes. These macroscopic signs of decomposition/degradation correlate with the destruction or impairment of biological structures such as plant vessels, leaves, seed pods, and plant cells, also correlating with alterations in the biochemical composition of the organic matter.

“Organic matter” is given its ordinary and accustomed meaning of carbon-based material that is or was associated with or produced by an organism that is or was a living organism, such as an agricultural product like fruits, vegetables, flowers and other ornamentals and landscaping materials.

A “defined space” is given its ordinary and accustomed meaning of a delimited space. In the context of the disclosure, a “defined space” is typically produced by a container that provides detectable boundaries defining the environment into discrete regions, such as an inner space or space contained within a container, which is a “defined space.”

“Breathable” means that gaseous vapor, such as aqueous vapor, can be transported through, such that a “breathable” barrier material is a material that permits the passage, or breathing of vapor such as aqueous vapor.

“Sachet” is given its ordinary and accustomed meaning of a bag, case, or packet that is semi-permeable to at least one gas or vapor. Sachets are frequently used to release perfumed scents.

“Encapsulated” means to be encased within, such as when a chemical compound is encased within a compound or composition comprising a hollow or semi-hollow core. Exemplary encapsulating materials are any of the cyclodextrins capable of forming structures comprising internal spaces for entrapping or encapsulating other compounds or materials, sometimes aided by covalent attachment of the entrapped or encapsulated material to the encapsulating compound or composition, such as a cyclodextrin.

“Herb” is given its ordinary and accustomed meaning of a plant or plant material used for food, medicine, flavoring, or perfume.

“Essential oil” means a concentrated, aromatic, typically oil-like compound of a plant. Essential oils may be volatile oils.

“Permeability” is given its ordinary and accustomed meaning of the relative capacity of a material to allow passage of a liquid or gas through the material. In the disclosure, sachet materials are relatively impermeable to aqueous liquids, but exhibit partial to complete permeability to aqueous gases.

“Cyclodextrins,” also known as cycloamyloses, constitute a family of sugars formed into rings (i.e., cyclic saccharides). Typically, cyclodextrins are glucopyranose units formed into 6-(α-), 7-(β-) or 8-(γ-)membered rings creating internal spaces suitable for transporting other compounds. As those of skill in the art understand, substitution or derivatization at the 2, 3, and 6-hydroxyl positions increases the water solubility of the cyclodextrin carrier, improving the ability of the molecule to function as a compound carrier in biological environments.

The following examples illustrate embodiments of the disclosure. Example 1 discloses the effect of thyme oil (TO) encapsulated in cyclodextrin and contained within a Tyvek® sachet to inhibit, prevent or delay microbe-mediated degradation of strawberries and blueberries. Example 2 demonstrates that cyclodextrin-encapsulated thyme oil has a protective effect on a flower (Snapdragons). Example 3 shows that thyme oil encapsulated in cyclodextrin inhibits, prevents or delays microbe-mediated degradation of a vegetable in the form of snap beans. Example 4 provides data demonstrating the wide applicability of the protective technology to organic matter such as agricultural products in demonstrating a protective effect on a number of rose varieties.

### EXAMPLE 1

### Strawberry and Blueberry

In these experiments, fruit were harvested from local farms, cooled to 5° C. using forced air and, for strawberry, packed in 454 g plastic clam shells (18×11×7 cm) and weighed. For blueberry, 170 g plastic clam shells (10.5×10.5×3.5 cm) were used. Two Tyvek® sachets containing 0.5 g of thyme oil encapsulated in cyclodextrin (TO:CD) were adhered to the bottom of the clamshell package. There are 4 treatments, 6 repetitions/treatment for strawberry and 12 repetitions/treatment for blueberry. For the treatments with modified atmosphere packaging film (MAP), the 6 or 12 treatment repetitions were placed in a box, wrapped and heat-sealed with MAP. Experiments with strawberry (Table 1) and blueberry (Table 2) were done to evaluate the antimicrobial effectiveness of a ratio of 16:84 thyme oil (TO, from Thymus vulgaris) cyclodextrin (CD) capsules enclosed within a Tyvek® sachet on strawberries stored for 8 days, and blueberries stored for 30 days at −1° C. with 94% humidity, with or without MAP (View Fresh A bag), or TO:CD sachets. Fruit stored using MAP (VFA bag) and TO:CD sachets had significantly less decay and less weight loss.

TABLE 1
Effects of TO:CD sachets on strawberry
fruit quality after 7 days storage at −1° C.^{a}

| | | Change in | | |
|---|---|---|---|---|
| | Disease | weight | | Total Soluble |
| | Incidence | after | Firmness | Solids (TSS) |
| Treatment | (%) | 7 days (g) | (N/cm²) | (° Brix) |
| −TO:CD sachet + | 36.4a | −1.81b | 6.75b | 7.22b |
| VFA bag | | | | |
| −TO:CD sachet − | 22.4b | −9.99a | 7.94b | 8.03a |
| VFA bag | | | | |
| +TO:CD sachet − | 13.9c | −8.21a | 7.94b | 7.13b |
| VFA bag | | | | |
| +TO:CD sachet + | 11.3c | −5.88b | 9.39a | 8.03a |
| VFA bag | | | | |

^{a}Means in the same column with the same letter are not significantly different (P ≦ 0.05).

TABLE 2
Effects of TO:CD sachets on blueberry fruit quality after 30 d
storage at −1° C. and 3 days at 15° C.^{a}

| | | | | Total |
|---|---|---|---|---|
| | Disease | | | Soluble |
| | Incidence | Change in wt | Firmness | Solids (TSS) |
| Treatment | (%) | after 7 d (g) | (N/cm2) | (° Brix) |
| −TO:CD sachet + | 42a | −10.2b | 13.5a | 12.6b |
| VFA bag | | | | |
| −TO:CD sachet − | 40a | −27.6a | 12.2b | 14.3a |
| VFA bag | | | | |
| +TO:CD sachet − | 42a | −25.6a | 12.3ab | 12.7b |
| VFA bag | | | | |
| +TO:CD sachet + | 28b | −12.8c | 13.4ab | 12.3b |
| VFA bag | | | | |

^{a}Means in the same column with the same letter are not significantly different (P ≦ 0.05).

### EXAMPLE 2

### Snapdragons

Six to eight snapdragon stems were placed in a bunch and wrapped in MAP sleeves (PEAKfreshUSA) fitted with 3 sachets either made of thyme oil encapsulated in cyclodextrin (TO:CD) or CD alone, and then placed in a commercial hydration solution (Chrysal Clear Professional 1) for 16 hours at 5° C. in the dark. Prior to storage, a flower on each stem was inoculated with 5 μL, of Botrytis cinerea conidial spore suspension (2500 spores). After 16 hours, the snapdragons were transferred to cardboard shipping boxes fitted with either two MCP (Ethylbloc™) sachets or without the MCP sachets. The snapdragons were simulated-shipped in the dark at 5° C. for 4 days. The snapdragons were then removed from the boxes, the Ethylbloc™ sachets discarded, and the snapdragon stems placed in vases containing commercial processing solution (Chrysal Clear Professional 2) and held at 5° C. for 1 day. The flowers were then removed from the sleeves, transferred to 25° C., and the stems were cut and placed in commercial vase solution (Chrysal Clear Professional 3) and evaluated for disease incidence and flower shatter.

TABLE 3
Effect of TO and MCP sachets on disease
incidence and flower shatter in cut snapdragons.

| | |
|---|---|
| Disease | Flower |
| Incidence (%) | Shatter (%) |

| Treatment | Day 5 | Day 14 | Day 5 | Day 14 |
|---|---|---|---|---|
| Control | 15a | 62a | 06 | 32a |
| +TO − MCP | 08b | 28b | 04 | 14b |
| −TO + MCP | 12a | 48a | 02 | 04c |
| +TO + MCP | 04b | 19b | 03 | 06c |

^{a}Means in the same column with the same letter are not significantly different (P ≦ 0.05).

### EXAMPLE 3

### Snap Beans

The effect of thyme oil on the resistance of Snap beans to microbe-mediated degradation over time was also investigated. Harvested Snap beans were inoculated with Botrytis spore suspension and placed in MAP bags with and without two TO:CD Tyvek sachets. Percentage of diseased beans was recorded after 3 days at 12° C., as recorded in Table 4.

TABLE 4

| Treatment | Disease (%) |
|---|---|
| Control | 78a |
| TO:CD | 48b |

### EXAMPLE 4

### Roses

To assess whether the technology disclosed herein would have wide applicability to biomaterials susceptible to microbe-mediated degradation, such as the susceptibility of a variety of cut flowers to such degradation, roses were also subjected to assessments of degradation in the presence or absence of thyme oil. Four varieties of rose were used in the studies, i.e., Parisienne, Akito, Vendela and Lindsey, and these varieties were exposed to Botrytis cinerea, the causative microbe of Gray Mold Disease. Rose flowers were inoculated with a Botrytis cinerea spore suspension, enclosed in a plastic sleeve with either two sachets containing cyclodextrin, or with two sachets containing thyme oil encapsulated in cyclodextrin, and incubated at 4° C. in commercial storage solution. Flowers were wrapped in bunches of six, with three six-flower bunches per treatment regimen. The Parisienne and Akito varieties of rose were examined after 3 days at 4° C. in the presence of Botrytis cinerea, and the results are presented in Table 5. The Vendela and Lindsey varieties were subjected to six days of exposure to Botrytis cinerea at 23° C. and the results are presented in Table 6. The Aalsmeer Gold variety of rose was assessed at 2 and 4 days of exposure to Botrytis cinerea at 23° C. The vase life of the Aalsmeer Gold was also determined. The data are provided in Table 7.

TABLE 5
Effect of Thyme Oil Sachet on Gray Mold
Disease in Cut Roses after 3 days at 4° C.

| | | | Disease Severity |
|---|---|---|---|
| Variety | Treatment | Disease Percentage | Rating^{y} |
| Parisienne | Control | 50.0a | 2.5a |
| | Thyme Oil Sachet | 5.6b | 0.28b |
| Akito | Control | 16.7a | 0.17a |
| | Thyme Oil Sachet | 0.0b | 0.0a |

^{y}Disease severity is the number of disease lesions/flower

TABLE 6
Effect of Thyme Oil Sachet on Gray Mold
Disease in Cut Roses after 6 days at 23° C.

| | | Disease | Disease | Vase Life |
|---|---|---|---|---|
| Variety | Treatment | Percentage | Severity Rating | (days) |
| Vendela | Control | 55.6a | 1.3a | 12.8a |
| | Thyme Oil Sachet | 0.0b | 0.6a | 16.3a |
| Lindsey | Control | 88.9a | 1.9a | 9.2a |
| | Thyme Oil Sachet | 22.2b | 1.0a | 9.6a |

TABLE 7
Effect of Thyme Oil Sachet on Gray Mold Disease in Cut
Roses after 2 and 4 days at 23° C.

| | | Disease Severity | Disease Severity | Vase Life |
|---|---|---|---|---|
| Variety | Treatment | Rating day 2 | Rating day 4 | (days) |
| Aalsmeer | Control | 2.5a | 3.7a | 5.7b |
| Gold | Thyme Oil | 1.7b | 2.6b | 7.9a |
| | Sachet | | | |

### EXAMPLE 5

The following Example discloses the effect of coating the interior surface of a plastic flower sleeve with a composition according to the disclosure, wherein the flower sleeve contained gerbera daisies or roses. More particularly, three experiments were conducted with gerbera daisies and one experiment was conducted with two different varieties of roses. For each experiment, thyme oil/cyclodextrin (TO/CD) capsules (see, e.g. Example 1) were mixed with soy protein isolate, paraffin wax and glycerine, and the mixture was painted on the inner side of a plastic film flower sleeve. The gerbera flowers were grown in the Rutgers greenhouse and, after cutting, flowers were dipped in Floralife Quick Dip Flowers and were inoculated with a Botrytis cinerea spore solution (5 μL, 10⁷ spores/mL) in the center of the disk, and placed in bunches (8-12 flowers) depending upon experiment and availability of flowers. The flower sleeves were closed with rubber bands at the top, and at the bottom around the stem. Flowers were left in buckets with Floralife flower food solution at 5° C. overnight and then placed dry in shipping boxes for three days at 5° C.

Flowers were taken out of boxes and placed in vases with Floralife flower food solution and put back in the cold room overnight. The next day, the gerbera daisies were taken out of the flower sleeves and transferred to vases with Floralife flower food solution at 23° C. and evaluated for disease after 4 days. We evaluated percentage of flowers with disease, and disease severity with the following scale for disease severity: 1=no infection; 2=inoculation site; 3=entire disc; 4=petals; 5=whole flower. The results are shown in Table 8, establishing that the percentage of flowers with disease was reduced by the protective composition applied to the flower sleeve and establishing that the disease severity was reduced for those flowers maintained in the presence of TO/CD.

TABLE 8
Effect of Coating Flower Sleeve with
Thyme Oil On Maintenance of Cut Daisies

| | | CD | TO/CD | P value |
|---|---|---|---|---|
| Experiment 1^{a} | Diseased Flowers | 44.3 | 20.6 | 0.014 |
| | (%) | | | |
| | Disease Severity | 1.74 | 1.32 | 0.015 |
| Experiment 2^{b} | Diseased Flowers | 65.0 | 41.2 | 0.05 |
| | (%) | | | |
| | Disease Severity | 2.2 | 1.49 | 0.001 |
| Experiment 3^{c} | Diseased Flowers | 68.9 | 45.3 | 0.023 |
| | (%) | | | |
| | Disease Severity | 2.08 | 1.67 | 0.021 |

^{a}experiment 1: 47 Gerbera daisies/treatment
^{b}experiment 2: CD, 40 Gerbera daisies; TO/CD, 47 Gerbera daisies
^{c}experiment 3: CD, 66 Gerbera daisies; TO/CD, 58 Gerbera daisies

The methods described above for the Gerbera daisy experiments were repeated for the experiment on the two varieties of roses (i.e., Blushing Akito and Cool Water). The flowers were grown in Columbia and shipped to facilities at Rutgers University. Botrytis cinerea spore suspension (5 μL, 10⁷ spores/mL), was added to the base of an inner whorl of petals.

TABLE 9
Effect of Coating Flower Sleeve with
Thyme Oil On Maintenance of Cut Roses

| | | CD | TO/CD | P value |
|---|---|---|---|---|
| Blushing Akito | Diseased Flowers | 68.9 | 49.6 | 0.045 |
| | (%) | | | |
| | Diseased | 5.8 | 1.6 | 0.018 |
| | Petals/Flower (%)^{a} | | | |
| | Flower openness | 4.3 | 4.2 | 0.62 |
| Cool Water | Diseased Flowers | 87.2 | 85.1 | 0.79 |
| | (%) | | | |
| | Diseased | 20.5 | 17.4 | 0.081 |
| | Petals/Flower (%)^{b} | | | |
| | Flower openness | 4.67 | 4.45 | 0.032 |

^{a}based on 37.1 petals per flower
^{b}based on 37.3 petals per flower

The percentage of diseased flowers was significantly reduced in ‘Blushing Akito’ rose and the number of infected petals was also significantly reduced. In ‘Cool Water’ rose, the number of diseased flowers and the number of petals infected was much greater than with ‘Blushing Akito’ and there were no treatment effects. The natural infection rate for ‘Blushing Akito’ was very low. Only three out of the twenty-four flowers placed directly in the vase at 23° C. after shipping showed symptoms of Botrytis cinerea infection after 7 days, although there was significant petal shatter and stem topple.

From the foregoing it will be appreciated that, although specific embodiments of the disclosure have been described herein for purposes of illustration, various modifications may be made without deviating from the spirit and scope of the disclosure.

1. A composition to reduce microbe-mediated decomposition of organic matter in a defined space comprising a breathable sachet of encapsulated herbal essential oil.

2. A composition to reduce microbe-mediated decomposition of organic matter in a defined space comprising a mixture of encapsulated herbal essential oil, protein, wax and glycerine.

3. The composition according to claim 2, wherein the protein is soy protein isolate.

4. The composition according to claim 2, wherein the wax is paraffin wax.

5. The composition according to claim 1 or claim 2, wherein the herbal essential oil is obtained from thyme.

6. The composition according to claim 5, wherein the essential oil obtained from thyme is thymol.

7. The composition according to claim 1, wherein the herbal essential oil is encapsulated in cyclodextrin.

8. The composition according to claim 7, wherein the cyclodextrin is selected from the group consisting of α-cyclodextrin, β-cyclodextrin and γ-cyclodextrin.

9. The composition according to claim 8, wherein the β-cyclodextrin is methyl-β-cyclodextrin.

10. The composition according to claim 1 wherein the sachet comprises Tyvek® membrane, Typar® membrane or Kleenguard® A40 membrane, or Homeguard® membrane.

11. The composition according to claim 1, wherein the microbe mediating decomposition is a species of Botrytis, Listeria, Clostridium, Salmonella, Shigella, Escherichia, Cryptosporidium, Giardia, Cyclospora, Pseudomonas, Xanthomonas, Zoogloea, Frauteuria, Lactobacillus, Pediococcus, and Leuconostoc.

12. The composition according to claim 11, wherein the microbe mediating decomposition is a species of the Botrytis genus.

13. The composition according to claim 12, wherein the microbe mediating decomposition is Botrytis cinerea.

14. A storage container for an agricultural product comprising the sachet according to claim 1.

15. A storage container for an agricultural product comprising a coating of the composition according to claim 2.

16-17. (canceled)

18. A method of inhibiting the decomposition of an agricultural product comprising adding a sachet according to claim 1 to a defined space comprising the agricultural product.

19. A method of inhibiting the decomposition of an agricultural product comprising applying the composition according to claim 2 to a defined space comprising the agricultural product.

20. The method according to claim 18 wherein the defined space is a storage container, a shipping container or a delivery container.

21. The method according to claim 18 further comprising adjusting the humidity in the defined space.

22. The method of claim 18, further comprising encapsulating the defined space with modified atmosphere packaging (MAP) film.

23. The method of claim 19, further comprising encapsulating the defined space with modified atmosphere packaging (MAP) film.
